(19) United States
(12) Patent Application Publication
(10) Pub. No.: US 2022/0335257 A1
(43) Pub. Date: Oct. 20, 2022

(54) NEURAL NETWORK BASED ANOMALY DETECTION FOR TIME-SERIES DATA

(71) Applicant: salesforce.com, inc., San Francisco, CA (US)

(72) Inventors: Devansh Arpit, Pacifica, CA (US); Huan Wang, Fremont, CA (US); Caiming Xiong, Menlo Park, CA (US)

(21) Appl. No.: 17/231,015

(22) Filed: Apr. 15, 2021

(51) Int. Cl. G06K 9/62; G06N 3/08

(52) U.S. Cl. CPC G06K 9/6257; G06K 9/6202; G06N 3/08

(57) ABSTRACT

A system uses a neural network to detect anomalies in time series data. The system trains the neural network for a fixed number of iterations using data from a time window of the time series. The system uses the loss value at the end of the fixed number of iterations for identifying anomalies in the time series data. For a time window, the system initializes the neural network to random values and trains the neural network for a fixed number of iterations using the data of the time window. After the fixed number of iterations, the system compares the loss values for various data points to a threshold value. Data points having loss value exceeding a threshold are identified as anomalous data points.

### BACKGROUND

### Field of Art

The disclosure relates to analysis of time series data in general and more specifically to using neural networks for identification of anomalies in time series data.

### Description of the Related Art

Time-series data is generated and processed in several contexts. Examples of time series data include sensor data, data generated by instrumented software that monitors utilization of resources such as processing resources, memory resources, storage resources, network resources, application usage data, and so on. Anomaly detection is typically performed to identify issues with systems that generate time series data. For example, anomalies in computing resource utilization may be an indication of server failure that is likely to happen in near future. Similarly, anomalies in network resource utilization may be an indication of network failure that is likely to happen in near future. Accurate and timely detection of anomalies in time series data allows such failures to be predicted in advance so that preventive actions can be taken.

Various techniques are used for anomaly detection including, clustering analysis, random forest techniques, and machine learning based models, for example, neural networks. Conventional neural network based techniques for anomaly detection require large amount of training data and significant computing resources for training the neural network. Furthermore, if the characteristics of the time series data being analyzed are different from the time series data used for training the neural networks, the neural network based techniques have low accuracy.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a block diagram of a system environment including a computing system for performing time series analysis, in accordance with an embodiment

FIG. 2 shows an example time series data and corresponding output of anomaly detection, in accordance with an embodiment.

FIG. 3 illustrates the system architecture of a time series processing module, in accordance with an embodiment.

FIG. 4 illustrates a neural network architecture used for anomaly detection, in accordance with an embodiment.

FIG. 5 illustrates the process of anomaly detection, in accordance with an embodiment.

FIG. 6 shows a flowchart illustrating the process of anomaly detection, according to an embodiment.

FIG. 7 is a high-level block diagram illustrating an example computer for implementing the client device and/or the computing system of FIG. 1.

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures.

### DETAILED DESCRIPTION

A system performs anomaly detection for time series data using machine learning based models, for example, neural networks. The system trains the neural network for a fixed number of iterations using data from a time window of the time series. The system uses the loss value at the end of the fixed number of iterations for identifying anomalies in the time series data. The loss value may represent a difference between the predicted data value and the actual data value of the time-series corresponding to the time value. For example, the system compares the loss value to a predetermined threshold value. The system uses the loss value to adjust parameters of the neural network, for example, using back propagation. The system also uses the loss values determined during the training phase to determine whether a data point of the time series represents an anomaly. If the loss value for a time point exceeds the threshold value, the system determines that the time value corresponds to an anomaly. In an embodiment, the anomaly is a point anomaly. The system performs the above steps for a new time interval. The system reinitializes the neural network for the new time interval and repeats the above steps.

Conventionally a neural network is trained using training dataset and the trained neural network is used at inference time to predict results. In contrast, the system according to various embodiments, determines anomalies during the training phase rather than through use of a trained neural network for making predictions.

The system trains the neural network using data within a time window and detects anomalies for data points within the time window based on the loss value determined during the time window. Conventional systems train a neural network until convergence, for example, until the loss value reaches below a threshold value. In contrast, the system according to various embodiments trains the neural network for a fixed number of iterations. After the fixed number of iterations, the system compares the loss values for data points within the time window with a threshold value. The system identifies data points having loss value exceeding the threshold value as anomalous data points. The system repeats the process for subsequent time intervals.

When the process is repeated for the next time window, the system discards the neural network trained using data of the previous time window. Accordingly, for each time window the system reinitializes the neural network, for example, using random values. Accordingly, the system does not train the neural network for future use as a predictor at inference time. The system simply runs the training process for using the loss determined during the training process for identifying point anomalies. After the anomalies are detected for a time window during the training phase of the neural network, the system discards the neural network and reinitializes the neural network using random values for the next time interval.

Furthermore, the system performs training of the neural network for a fixed number of iterations. Conventionally, the training of a neural network is performed until some convergence criteria is met, for example, until a loss value is below a threshold indicating convergence is reached. The system does not attempt to reach convergence but uses the training dynamics to determine anomalies. Accordingly, the system does not aim to generate a fully trained neural network.

As a result, the process used for detecting anomalies in time series data is computationally efficient as the neural network is trained only for a few iterations and not until convergence. The accuracy of the techniques disclosed is either better or at least as good as other techniques that fully train the neural networks. Accordingly, the system achieves high accuracy with fewer computational resources. Therefore, the disclosed techniques improve the computational efficiency of the process of detecting anomalies in time series data and provide a technological advantage over conventional techniques.

### Overall System Environment

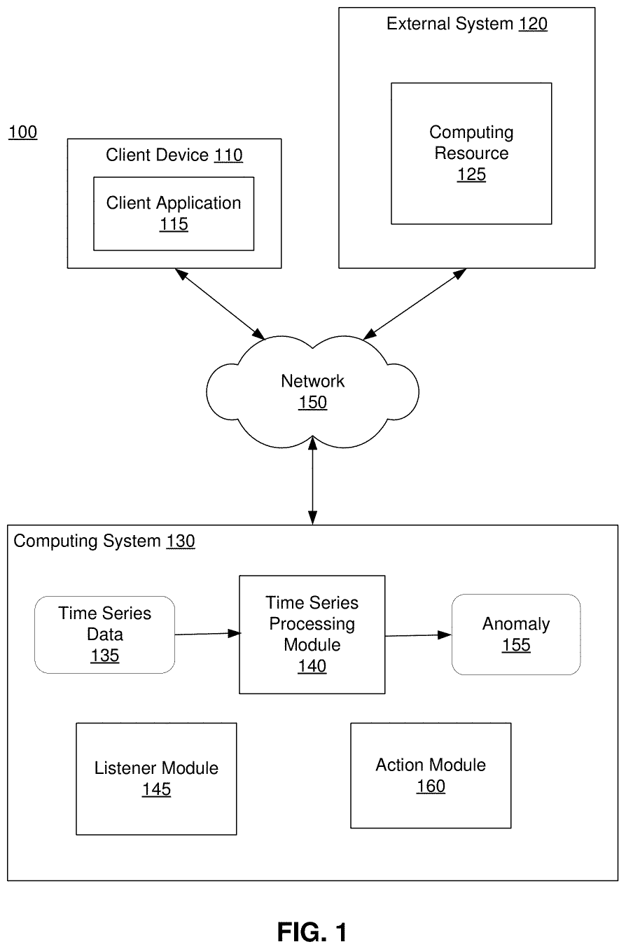

FIG. 1 is a block diagram of a system environment including a computing system for performing time series analysis, in accordance with an embodiment. The system environment 100 shown in FIG. 1 comprises a computing system 130, client device 110, an external system 120, and a network 150. In alternative configurations, different and/or additional components may be included in the system environment 100. The computing system 130 may be an online system or a system working offline, for example, by performing batch processing for performing anomaly detection.

The computing system 130 includes a time series processing module 140, a listener module 145, and an action module 160. The listener module 145 receives time series data 135 from one or more sources, for example, external systems 120. The time series processing module 140 performs anomaly detection on the time series data 135 to detect anomalies, for example point anomalies 155. The action module 160 takes an action based on the detected anomaly 155, for example, by sending an alert message to a user or taking an automated remedial action. In some embodiments, the computing system 130 itself may be the source of time series data.

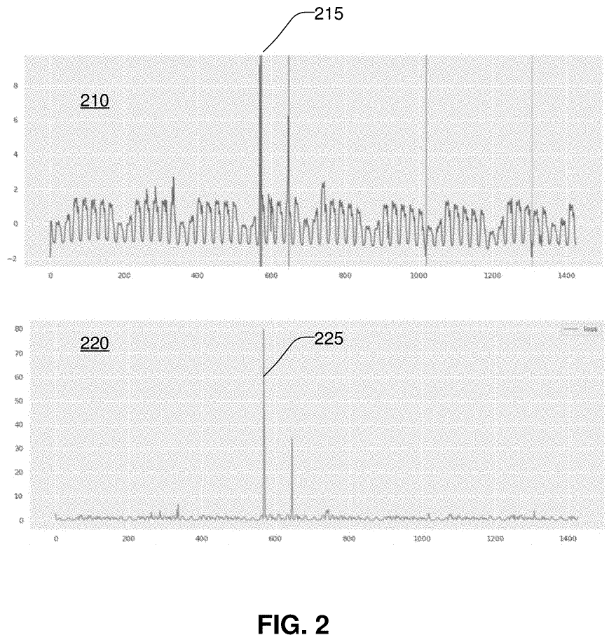

FIG. 2 shows an example time series data and corresponding output of anomaly detection performed by the time series processing module 140, in accordance with an embodiment. The chart 210 represents the time series data 135 received by the listener module 140 and provided as input to the time series processing module 140. The time series processing module 140 outputs scores indicating occurrence of anomalies in the time series data shown in chart 210. Example scores determined based on the time series data of chart 210 are shown as chart 220. As shown in FIG. 2, the computing system 130 determines occurrence of an anomaly 155 if the scores generated by the time series processing module 140 exceed a predetermined threshold, for example, score increases at point 225 based on a point anomaly detected in time series data at point 215.

Anomaly detection may be performed for system maintenance, for example, to detect system problems in advance. For example, anomalies in computing resource utilization may be an indication of server failure that may happen in near future. Similarly, anomalies in network resource utilization may be an indication of network failure that may happen in near future. Therefore, accurate and timely detection of anomalies if important for such time series data analysis.

The computing system 130 receives time series data 135 from sources, for example, from the external system 120. For example, the external system 120 includes computing resources 125 that generate time series data. Examples of computing resources including memory resources, processing resources, storage resources, network resources, and so on. The external system 120 may execute instrumented software that generates time series data representing resource usage of one or more resources. For example, the external system 120 may execute instrumented software that monitors the network usage and reports metrics indicating network usage on a periodic basis. The reported data represents a time series 135 that is received by the computing system 130. The time series processing module 140 may detect anomalies 155 that represent potential issues with a computing resource, for example, a potential failure that is likely to occur. The action module 160 may take appropriate action responsive to detection of the anomaly 155, for example, by sending an alert to a system administrator or by taking an automatic remedial action, for example, by allocating additional computing resources for a task or process if the system determines that the anomaly 155 indicates shortage of a particular computing resource allocated for the task or process. For example, the computing system 130 may determine that a point anomaly detected in a time series representing network usage indicates lack of sufficient network resources for a communication channel, the action module 160 may reallocate network resources to provide additional network bandwidth to the communication channel. As another example, the time series data may represent a number of pages swapped by a process and the anomaly 155 may be caused by an increase in the number of pages swapped indicating a shortage of storage resources. The action module 160 in response to detection of the anomaly 155 may allocate additional storage to the process.

Time series data 135 may be reported by other sources for example, sensors that monitor some real-world data and report it on a periodic basis, for example, temperature, pressure, weight, light intensity, and so on. For example, a sensor may monitor temperature or pressure of an industrial process that performs a chemical reaction and report it on a periodic basis as time series data 135. The action module 160 may perform an action that controls the industrial process in response to detection of the anomaly 155, for example, by controlling the industrial process to adjust the rate the chemical reaction.

The time series data 135 may represent user actions, for example, user interactions with an online system. For example, the computing system 130 may monitor user interactions with an online system to detect anomalies in the user interaction. The point anomaly may be an indication of a change in user behavior or an issue with the online system receiving the user interactions. The action module 160 may take appropriate action based on detection of a point anomaly 155, for example, by sending an alert message to a user. The alert message may provide a recommendation of an action that the user may take to adjust the online system parameters in response to the anomaly detection. For example, if the anomaly 155 is determined as an indication of increase in demand for a specific product, the online system may initiate an online campaign for the product to provide additional users with information describing the product.

FIG. 1 shows a single instance of various components such as external system, client devices, and so on. However, there may be multiple instances of each of these components. For example, there may be several computing systems 130 and dozens or hundreds of client devices 110 or external system 120 in communication with each computing system 130. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral.

The client devices 110 are computing devices such as smartphones with an operating system such as ANDROID® or APPLE® IOS®, tablet computers, laptop computers, desktop computers, electronic stereos in automobiles or other vehicles, or any other type of network-enabled device on which digital content may be listened to or otherwise experienced. Typical client devices 110 include the hardware and software needed to connect to the network 150 (e.g., via Wifi and/or 4G or other wireless telecommunication standards).

The network 150 provides a communication infrastructure between the client devices 110, external systems 120, and computing system 130. The network 150 is typically the Internet, but may be any network, including but not limited to a Local Area Network (LAN), a Metropolitan Area Network (MAN), a Wide Area Network (WAN), a mobile wired or wireless network, a private network, or a virtual private network. Portions of the network 150 may be provided by links using communications technologies including WiFi based on the IEEE 802.11 standard, the BLUETOOTH short range standard, and the Wireless Universal Serial Bus (USB) standard.

### System Architecture

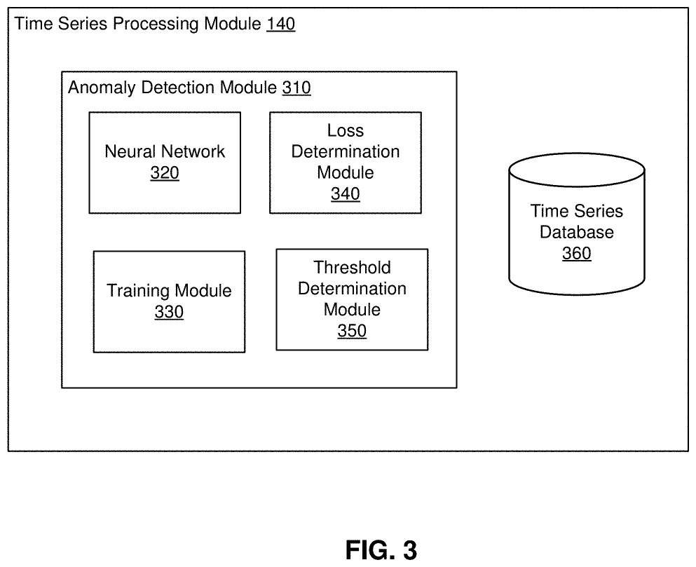

FIG. 3 illustrates the system architecture of a time series processing module, in accordance with an embodiment. The time series processing module 140 comprises an anomaly detection module 310 and a time series database 360. The time series processing module 140 may perform various types of processing of the time series data including anomaly detection. The anomaly detection module 310 performs anomaly detection of time series data stored in time series database 360. The anomaly detection module 310 comprises a neural network 320, a loss determination module 340, a training module 330, and a threshold determination module 350. Conventional components such as network interfaces, security functions, load balancers, failover servers, management and network operation consoles, and the like are not shown so as to not obscure the details of the system architecture.

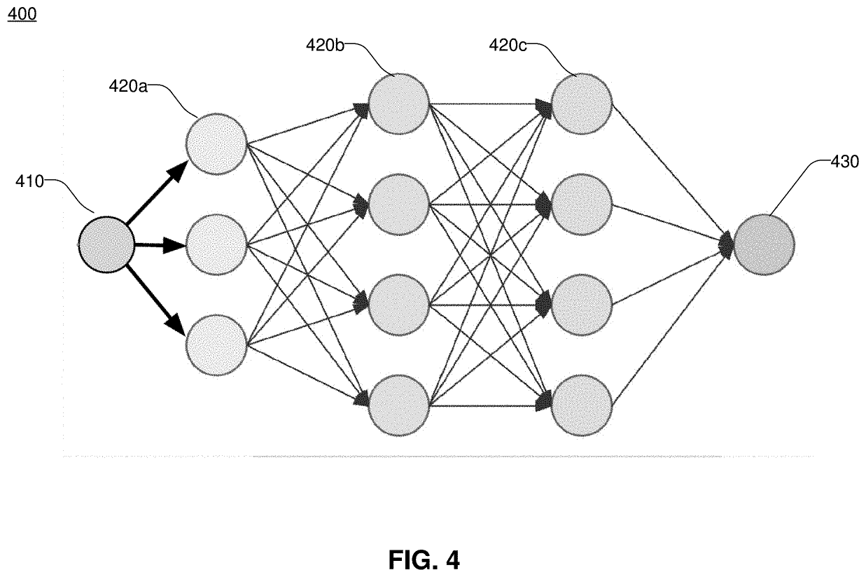

In an embodiment, the neural network 320 is a multi-layer perceptron. FIG. 4 illustrates a neural network architecture used for anomaly detection, in accordance with an embodiment. FIG. 4 shows an example neural network 400 that includes an input layer 410, one or more hidden layers 420, and an output layer 430. The input layer 410 is configured to receive a time value as input and the output layer 430 is configured to predict a data value corresponding to the input time value.

The loss determination module 340 determines a loss value based on the predictions of a neural network being trained. The loss value represents a difference between the predicted data value and the corresponding known data value of the time-series corresponding to the time value. For example, if the time series data value is D1 for a time value T1, the neural network predicts a value D1′ and determines the loss value as based on a difference between D1′ and D1. The loss value may be determined using any of various possible metrics, for example, root mean square, mean absolute value, and so on.

The training module 330 performs the training process of a neural network. The training module 330 initializes the neural network, for example, by setting the parameters of the neural network to random values. The training module 330 predicts values of the time series data using the neural network and determines the loss values by invoking the loss determination module 340. The training module 330 adjusts the parameters of the neural network based on the loss value, for example, using back propagation, to minimize the loss value.

The threshold determination module 350 determines the threshold value used for determining the point anomalies. The anomaly detection module 310 compares loss values of the neural network with the threshold value determined by the threshold determination module 350 to determine whether a point anomaly exists at a time value in the time series data. In an embodiment, the threshold determination module 350 adjusts a threshold value based on comparison of anomalies identified and known anomalies. For example, the point anomalies may be presented to a user to receive feedback describing whether the point anomalies were identified accurately.

If the anomaly detection module 310 receives feedback indicating that one or more known point anomalies were not detected by the anomaly detection module 310, the threshold value may be reduced so that point anomalies similar to the missed point anomalies can be identified subsequently. If the anomaly detection module 310 receives feedback indicating that one or more known point anomalies were identified by the anomaly detection module 310 but were not actual point anomalies, the threshold value may be increased so that point anomalies similar to the spurious point anomalies previously identified get filtered out subsequently and are not detected. The threshold determination module 350 uses the adjusted threshold value for identifying anomalies for subsequent time windows.

### Anomaly Detection Process

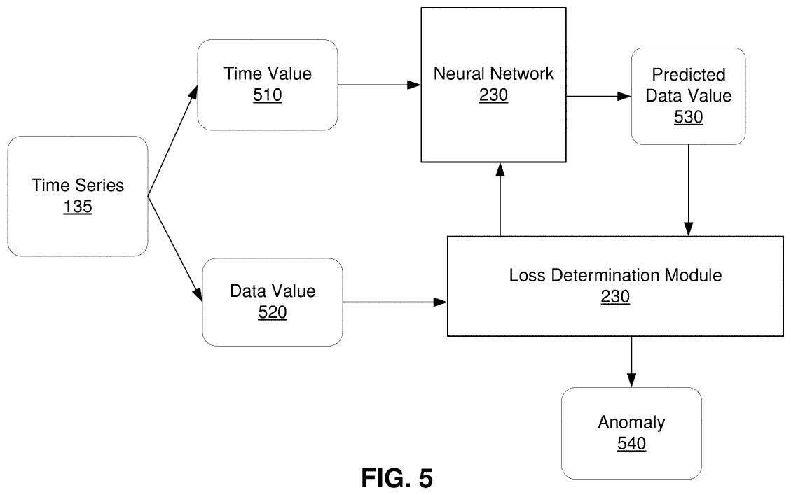

FIG. 5 illustrates the process of anomaly detection, in accordance with an embodiment. As shown in FIG. 5, the time series data 135 includes time values 510 and data values 520. For example, the time series data 135 may be represented as a sequence of tuples (Tₙ, Dₙ) where Tₙ represents a time value 510 and Dₙ represents a data value 520. The neural network 320 receives time values 510 as input and predicts data values 530. The loss determination module 320 receives as input the predicted data value 530 and the actual data value 520 of the time series and determines a loss value that is used as feedback for adjusting the parameters of the neural network. The loss values are used by the anomaly detection module 310 for determining anomalies 540 by comparing the loss values against a threshold value.

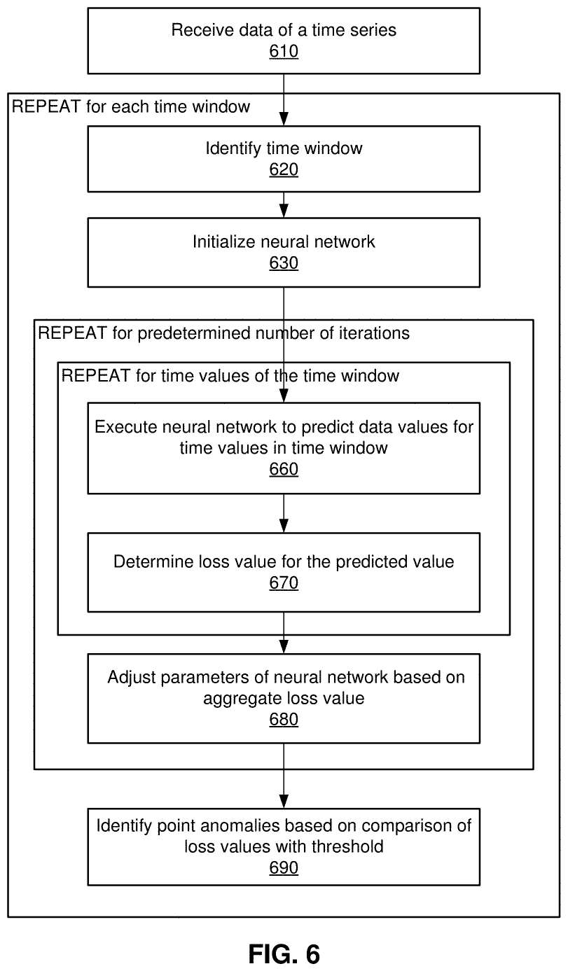

FIG. 6 shows a flowchart illustrating the process of anomaly detection, according to an embodiment. The steps described herein may be performed in an order different from that indicated herein. Furthermore, each step may be performed by a module different from that indicated herein.

The time series processing module 140 receives 610 a time-series comprising a sequence of data values. Each data value of the time series is associated with a time value. The time series processing module 140 processes different time windows of the time series data to determine point anomalies in each time window. A time window represents a range of time values. Accordingly, the time series processing module 140 trains a neural network based on data values of the time window and detects point values within the time window based on the loss values determined during the training phase of the neural network based on the time series data of the time window. The time series processing module 140 repeats the following steps for each time window.

The time series processing module 140 identifies 620 a time window representing a range of time values. The time series processing module 140 initializes the neural network 630 for the time window. The time series processing module 140 trains the neural network for a predetermined number of iterations, by repeating the following steps 660, 670, and 680. For each iteration, the time series processing module 140 repeats the steps 660 and 670 for time values within the time window. For a time value of the time window, the time series processing module 140 executes 660 the neural network to predict a data value for the time value. The time series processing module 140 determines 670 a loss value based on the predicted data value. After repeating the steps 660 and 670 for a set of time values of the time window, the time series processing module 140 determines an aggregate loss value across the set of time values.

The time series processing module 140 adjusts 680 parameters of the neural network based on the aggregate loss value. The steps of determining the aggregate loss value and adjusting the parameters of the neural network are repeated for each iteration. After the predetermined number of iterations, the time series processing module 140 identifies 690 point anomalies in the time window as follows. If a loss value corresponding to a particular time value within the time window exceeds a threshold, the time series processing module 140 identifies the corresponding data value as an anomaly. The computing system 130 may store information describing the data values identified as point anomalies. The action module 160 may take actions based on the identified point anomalies, for example, sending an alert message to a user describing a point anomaly, sending the information describing the point anomaly for displaying via a user interface, recommending a remedial action based on the point anomaly, or performing a remedial action based on the point anomaly.

The time series processing module 140 initializes the neural network for each time window and discards the neural network at the end of processing of the time window. The neural network may be initialized by setting the parameter values of the neural network to random values. Accordingly, the time series processing module 140 performs the steps of training the neural network but does not use the trained neural network for any processing. The time series processing module 140 uses the loss value determined during the training process to detect point anomalies in the time series data of the time window and then repeats the process for the next time window. Furthermore, the time series processing module 140 trains the neural network for a predetermined number of iterations rather than training the neural network until an aggregate loss value is below a threshold value. The predetermined number of iterations may be configurable by a user or set to a default value. The predetermined number of iterations is set to a value that is less than the number of iterations required to ensure that the aggregate loss value reaches below a threshold value. This ensures that the anomaly detection process is executed efficiently since the goal of the time series processing module 140 is not to generate a trained model that can be used at inference time for making predictions but only to go through a partial training process so that the loss value during the partial training process can be used to identify the point anomalies.

### Performance Improvement

Experimental data shows improvement in performance obtained by using the techniques disclosed herein. The following table shows F1 scores obtained by executing various models on different datasets. The F1 score is calculated as F1=2*precision*recall/(precision+recall). Each column represents a particular dataset and each row represents a particular model. The disclosed techniques were compared against other models including WinStats, ISF, RRCF (robust random cut forest), and Prophet. The first row represents the data for a system according to an embodiment as disclosed and the remaining rows represent other models that do not use the techniques disclosed, for example, (1) WinStats (Window statistics) a technique that uses statistics of data in the time series to determine which specific points are anomalous, (2) ISF (isolation forest): a technique based on decision tree algorithm, (3) RRCF (robust random cut forest): a technique similar to isolation forest but modified to work on streaming data, and (3) Prophet: a regression model based approach.

TABLE I

| | Yahoo A1 | Yahoo A2 | Yahoo A3 | Yahoo A4 | IOps | NAB all | Average |
|---|---|---|---|---|---|---|---|
| Disclosed | 0.48 | 0.72 | 0.89 | 0.59 | 0.28 | 0.22 | 0.53 |
| System | | | | | | | |
| (no retraining) | | | | | | | |
| WinStats | 0.49 | 0.63 | 0.10 | 0.15 | 0.35 | 0.25 | 0.33 |
| (retrain daily) | | | | | | | |
| ISF | 0.30 | 0.46 | 0.58 | 0.23 | 0.32 | 0.21 | 0.35 |
| (retrain 7 d) | | | | | | | |
| RRCF | 0.26 | 0.47 | 0.42 | 0.16 | 0.29 | 0.20 | 0.30 |
| (retrain 7 d) | | | | | | | |
| Prophet | 0.27 | 0.66 | 0.97 | 0.43 | 0.04 | 0.16 | 0.42 |
| (retrain 7 d) | | | | | | | |

As shown in the table above, the F1 scores of the system based on the disclosed techniques performed either better than all the models tested or close to the best model although the system predicts the anomaly without requiring any retraining. For example, the “average” column at the end represents the average performance of all the models for various data sets and shows that the average performance of the system as disclosed is better than all the models that were studied. Accordingly, the system disclosed is efficient computationally since it requires significantly fewer computing resources used in training of the model compared to other techniques while performing at least as well as the other techniques or better. The average performance of the disclosed techniques across all data sets was better than all the other techniques tested.

### Computer Architecture

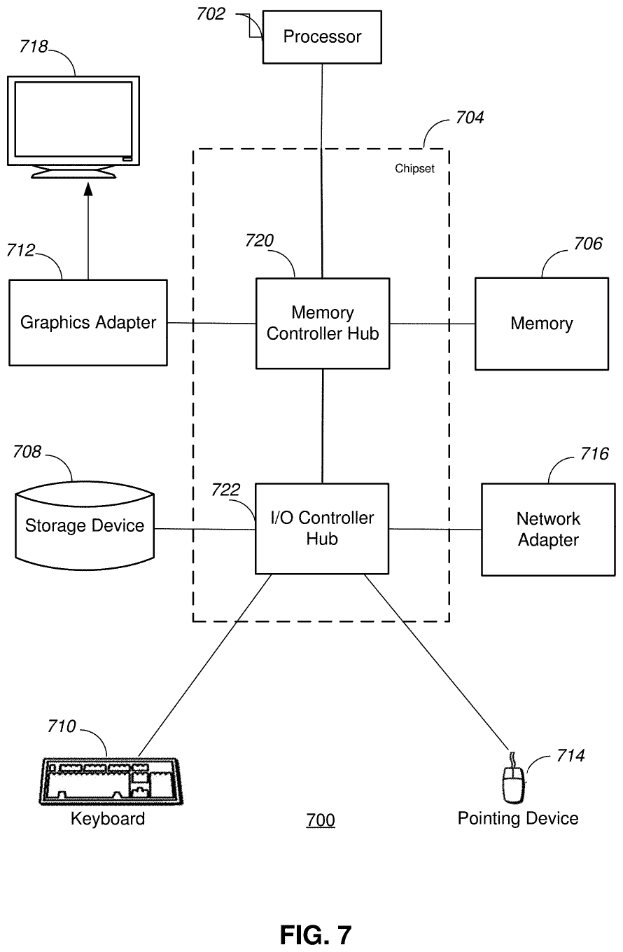

FIG. 7 is a high-level block diagram illustrating an example computer for implementing the client device and/or the computing system of FIG. 1. The computer 700 includes at least one processor 702 coupled to a chipset 704. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, an input device 714, and network adapter 716 are coupled to the I/O controller hub 722. Other embodiments of the computer 700 have different architectures.

The storage device 708 is a non-transitory computer-readable storage medium such as a hard drive, compact disk read-only memory (CD-ROM), DVD, or a solid-state memory device. The memory 706 holds instructions and data used by the processor 702. The input interface 714 is a touch-screen interface, a mouse, track ball, or other type of pointing device, a keyboard, or some combination thereof, and is used to input data into the computer 700. In some embodiments, the computer 700 may be configured to receive input (e.g., commands) from the input interface 714 via gestures from the user. The graphics adapter 712 displays images and other information on the display 718. The network adapter 716 couples the computer 700 to one or more computer networks.

The computer 700 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 708, loaded into the memory 706, and executed by the processor 702.

The types of computers 700 used by the entities of FIG. 1 can vary depending upon the embodiment and the processing power required by the entity. The computers 700 can lack some of the components described above, such as graphics adapters 712, and displays 718. For example, the computing system 130 can be formed of multiple blade servers communicating through a network such as in a server farm.

### Alternative Embodiments

It is to be understood that the Figures and descriptions of the disclosed invention have been simplified to illustrate elements that are relevant for a clear understanding of the present invention, while eliminating, for the purpose of clarity, many other elements found in a typical distributed system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

We claim:

1. A computer implemented method for identifying anomalies in time-series data, the method comprising:
receiving a time-series comprising a sequence of data values, each data value associated with a time value;
identifying a time window representing a range of time values;
identifying anomalies of the time-series data in the time window, comprising:
initializing a neural network configured to receive an input time value and predict a data value of the time-series for the input time value;
training the neural network for a predetermined number of iterations, comprising:
for one or more time values of the time window:
executing the neural network to predict a data value for the time value, and
determining a loss value based on the predicted data value;
adjusting parameters of the neural network based on the loss values;
determining anomalies in the time window after the predetermined number of iterations comprising:
responsive to a loss value corresponding to a time value exceeding a threshold, identifying the corresponding data value as an anomaly; and
storing information describing one or more data values identified as anomalies.

2. The computer implemented method of claim 1, wherein the time anomaly is a point time anomaly.

3. The computer implemented method of claim 1, wherein initializing the neural network comprises assigning random values to parameters of the neural network.

4. The computer implemented method of claim 1, wherein the time window is a first time window, the range of time values is a first range of time values, the method comprising:
identifying a second time window representing a second range of time values;
identifying anomalies in the second time window, comprising:
reinitializing the neural network for the second time window;
training the neural network for the predetermined number of iterations using data values of the second time window; and
responsive to a loss value for a time value of the second time window exceeding the threshold, identifying the data value for the time value as an anomaly.

5. The computer implemented method of claim 1, wherein a loss value represents a difference between the predicted data value and the data value of the time-series corresponding to the time value.

6. The computer implemented method of claim 1, wherein adjusting parameters of the neural network comprises:
determining an aggregate loss value based on the loss values corresponding to the time values of the time window; and
adjusting parameters of the neural network based on the aggregate loss value.

7. The computer implemented method of claim 1, wherein the time-series represents resource utilization of a computing resource, the method further comprising:
identifying a potential resource failure based on the identified anomalies; and
sending a message reporting the potential resource failure.

8. The computer implemented method of claim 7, wherein the computing resource is one of:
a processing resource,
a memory resource,
a network resource, or
a storage resource.

9. The computer implemented method of claim 7, wherein the time-series represents resource utilization of a computing resource, the method further comprising:
taking a remedial action for preventing the potential resource failure.

10. The computer implemented method of claim 1, wherein the neural network is a multi-layered perceptron configured to receive a scalar input and output a scalar value.

11. The computer implemented method of claim 1, further comprising.
adjusting the threshold value based on comparison of one or more anomalies identified and known anomalies; and
using the adjusted threshold value for identifying anomalies for one or more other time windows.

12. A non-transitory computer readable storage medium storing instructions that when executed by the one or more computer processors causes the one or more computer processors to:
receive a time-series comprising a sequence of data values, each data value associated with a time value;
identify a time window representing a range of time values;
identify anomalies of the time-series data in the time window, wherein the identifying causes the one or more computer processors to:
initialize a neural network configured to receive an input time value and predict a data value of the time-series for the input time value;
train the neural network for a predetermined number of iterations, wherein the training causes the one or more computer processors to:
for one or more time values of the time window:
execute the neural network to predict a data value for the time value, and
determine a loss value based on the predicted data value;
adjust parameters of the neural network based on the loss values;
determine anomalies in the time window after the predetermined number of iterations wherein the determining anomalies causes the one or more computer processors to:
responsive to a loss value corresponding to a time value exceeding a threshold, identify the corresponding data value as an anomaly; and
store information describing one or more data values identified as anomalies.

13. The non-transitory computer readable storage medium of claim 12, wherein the time window is a first time window, the range of time values is a first range of time values, wherein the instructions further cause the one or more computer processors to:
identify a second time window representing a second range of time values;
identify anomalies in the second time window, by causing the one or more computer processors to:
reinitialize the neural network for the second time window;
train the neural network for the predetermined number of iterations using data values of the second time window; and
responsive to a loss value for a time value of the second time window exceeding the threshold, identify the data value for the time value as an anomaly.

14. The non-transitory computer readable storage medium of claim 12, wherein instructions for adjusting parameters of the neural network cause the one or more computer processors to:
determine an aggregate loss value based on the loss values corresponding to the time values of the time window; and
adjust parameters of the neural network based on the aggregate loss value.

15. The non-transitory computer readable storage medium of claim 12, wherein the time-series represents resource utilization of a computing resource, wherein the instructions further cause the one or more computer processors to:
identify a potential resource failure based on the identified anomalies; and
send a message reporting the potential resource failure.

16. The non-transitory computer readable storage medium of claim 12, wherein the instructions further cause the one or more computer processors to:
adjust the threshold value based on comparison of one or more anomalies identified and known anomalies; and
use the adjusted threshold value for identifying anomalies for one or more other time windows.

17. A computer system comprising:
one or more computer processors; and
non-transitory computer readable storage medium storing instructions that when executed by the one or more computer processors causes the one or more computer processors to:
receive a time-series comprising a sequence of data values, each data value associated with a time value;
identify a time window representing a range of time values;
identify anomalies of the time-series data in the time window, wherein the identifying causes the one or more computer processors to:
initialize a neural network configured to receive an input time value and predict a data value of the time-series for the input time value;
train the neural network for a predetermined number of iterations, wherein the training causes the one or more computer processors to:
for one or more time values of the time window:
execute the neural network to predict a data value for the time value, and
determine a loss value based on the predicted data value;
adjust parameters of the neural network based on the loss values;
determine anomalies in the time window after the predetermined number of iterations wherein the determining anomalies causes the one or more computer processors to:
responsive to a loss value corresponding to a time value exceeding a threshold, identify the corresponding data value as an anomaly; and
store information describing one or more data values identified as anomalies.

18. The computer system of claim 17, wherein the time window is a first time window, the range of time values is a first range of time values, wherein the instructions further cause the one or more computer processors to:
identify a second time window representing a second range of time values;
identify anomalies in the second time window, by causing the one or more computer processors to:
reinitialize the neural network for the second time window;
train the neural network for the predetermined number of iterations using data values of the second time window; and
responsive to a loss value for a time value of the second time window exceeding the threshold, identify the data value for the time value as an anomaly.

19. The computer system of claim 17, wherein instructions for adjusting parameters of the neural network cause the one or more computer processors to:
determine an aggregate loss value based on the loss values corresponding to the time values of the time window; and
adjust parameters of the neural network based on the aggregate loss value.

20. The computer system of claim 17, wherein the instructions further cause the one or more computer processors to:
adjust the threshold value based on comparison of one or more anomalies identified and known anomalies; and
use the adjusted threshold value for identifying anomalies for one or more other time windows.
